(19) United States
(12) Patent Application Publication
(10) Pub. No.: US 2025/0144596 A1
(43) Pub. Date: May 8, 2025

(54) DEVICE FOR OIL ABSORPTION BASED ON FIBER-BASED MEDICAL WASTE

(71) Applicant: Qatar Foundation for Education, Science and Community Development, Doha (QA)

(72) Inventors: Oluwaseun Ogunbiyi, Doha (QA); Zhaoyang Liu, Doha (QA); Radee Al-Rewaily, Doha (QA)

(21) Appl. No.: 18/912,093

(22) Filed: Oct. 10, 2024

Related U.S. Application Data
(60) Provisional application No. 63/546,986, filed on Nov. 2, 2023.

(51) Int. Cl. B01J 20/26; C09K 3/32

(52) U.S. Cl. CPC B01J 20/26; C09K 3/32

(57) ABSTRACT

A device for oil absorption based on fiber-based medical waste. In one embodiment, the device is an outer bag filled with fillers, both the bag and the filler are made from the fiber-based waste materials, and the outside bag is coated with a functional polymer to enhance the oil absorption and retention capacity of the device.

### RELATED APPLICATIONS

The present disclosure claims priority to U.S. Provisional Patent Application 63/546,986 having a filing date of Nov. 2, 2023, the entirety of which is incorporated herein.

### BACKGROUND

Oil spills are triggered by oil and gas related activities including accidents affecting vessels, which can pollute the water ways, as well as the environment and significantly endanger the ecosystem. Oil spill cleanup can be affected by ocean currents, which can extend the oil spill area. Tanker cleaning activities lead to around half of the oil spills, which adversely affect coastal countries with prolonged disruption of services. Efficient responses to oil spill events are important to the continuous operation of oil and gas and desalination activities. Oil absorbents are commonly used for oil spill cleanup. The commercial oil absorbent is made of synthetic materials such as polypropylene (PP). There is huge amount of such absorbent materials need for coping with oil spill emergency.

The use of single-use medical fiber-based plastics (such as, bed cover, apron, face mask, etc.) in the health care sector to protect human life produces a high volume of plastic waste. Moreover, single-use medical fiber-based plastics have become essential for usage by the general community especially during the peak of the Covid-19 pandemic. Many governments have declared essential use of masks in public areas. The use of nonwoven PP fabric for producing medical disposable face masks and clothes is increasing globally. These create an environmental hazard due to the incomplete biodegradation of polypropylene over an extended period.

A need exists for an oil absorption device that uses fiber-based medical waste.

### SUMMARY

According to one non-limiting aspect of the present disclosure, a device for oil absorption based on fiber-based medical waste. In one embodiment, the device is an outer bag filled with fillers, both the bag and the filler are made from the fiber-based waste materials, and the outside bag is coated with a functional polymer, such as Polyaniline, Polydimethylsiloxane, Poly(ethylene terephthalate), Poly(vinylidene fluoride), to enhance the oil absorption and retention capacity of the device.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 shows the materials and structure of commercial faces masks, according to an example embodiment of the present disclosure.

FIG. 2 shows commercial absorbent pads made of polypropylene fiber, according to an example embodiment of the present disclosure.

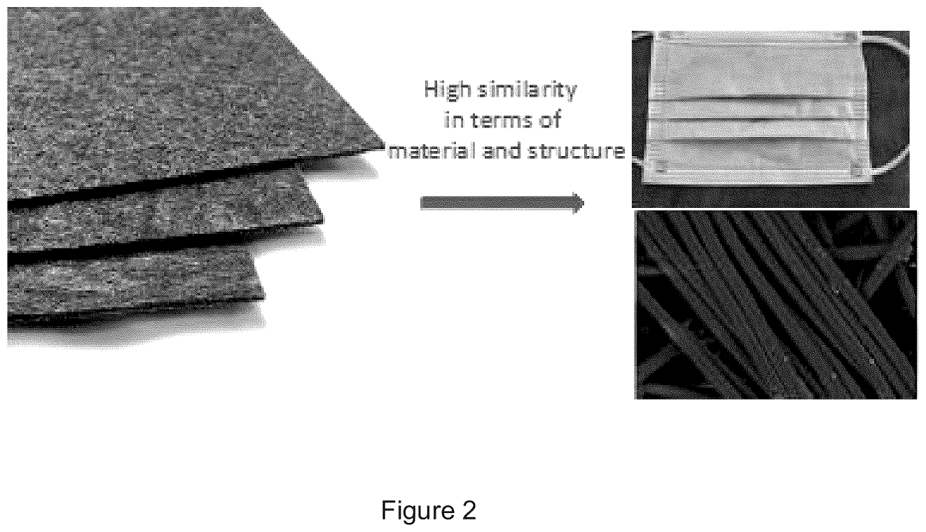

FIGS. 3A-D show surface wettability of face masks at various times, A shows 0 seconds, B shows 5 seconds, C shows 15 seconds, and D shows 30 seconds, according to an example embodiment of the present disclosure.

FIG. 4 shows an absorbent bag made of face mask materials with shredded face mask material filled inside, where the outside cover is coated with functional polymers to enhance the oil absorption and retention, according to an example embodiment of the present disclosure.

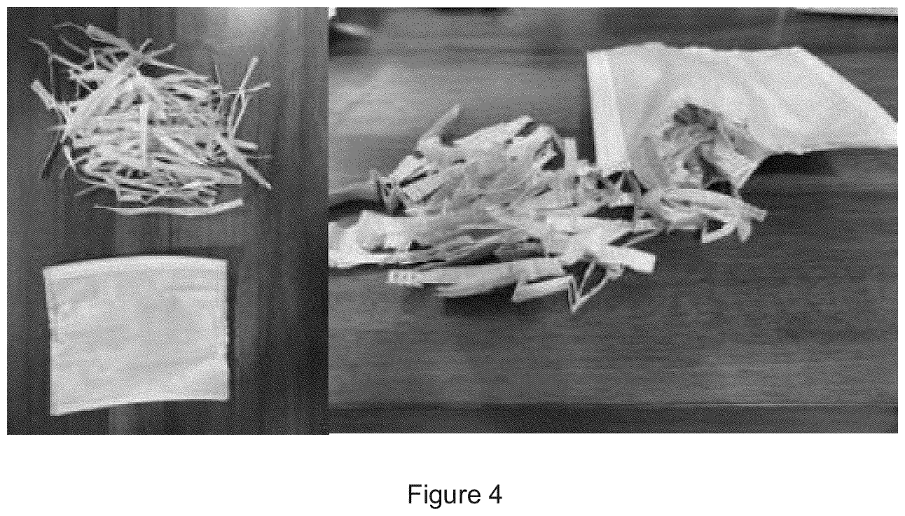

FIG. 5 shows an SEM image of PVDF-coated outside cover of the device, where the outside cover was coated with functional polymers to enhance the oil absorption and retention, according to an example embodiment of the present disclosure.

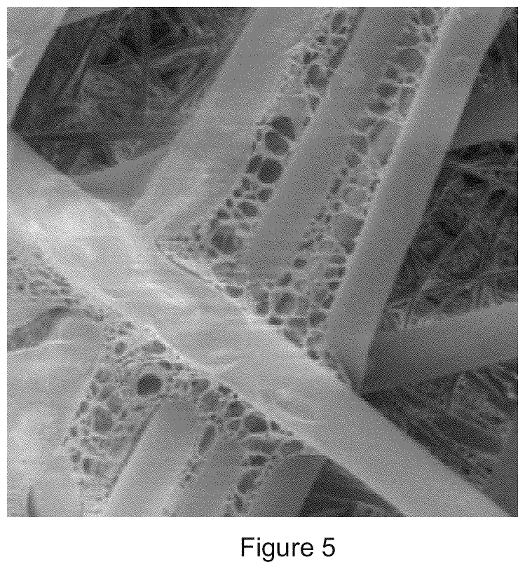

FIG. 6 shows the use of a mechanical shaker to simulate oil spill occurrence under the conditions of sea water with waves and tides, according to an example embodiment of the present disclosure.

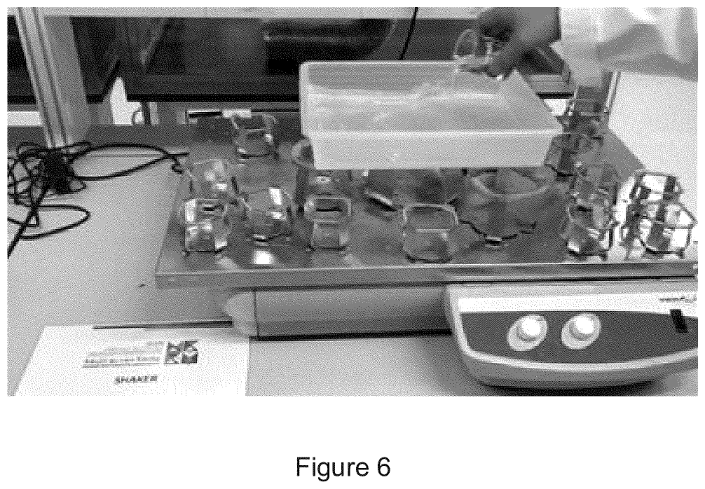

FIG. 7 shows a performance test of in-house made oil absorbent bag by soaking it in the water with simulated oil spill, according to an example embodiment of the present disclosure.

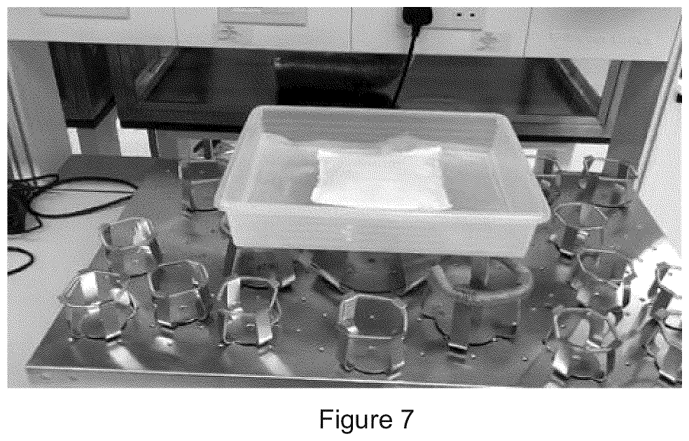

FIG. 8 shows oil absorption capacities of face masks under the condition of pure oil, according to an example embodiment of the present disclosure.

FIG. 9 shows oil absorption capacities of face masks under the condition of 10% oil in fresh water, according to an example embodiment of the present disclosure.

FIG. 10 shows oil absorption capacities of face masks under the condition of 10% oil in salty water (40,000 ppm salt), according to an example embodiment of the present disclosure.

### DETAILED DESCRIPTION

The present disclosure generally relates to a device for oil absorption based on fiber-based medical waste.

The disclosed technology proposes a device that uses medical fiber-based plastic waste (such as, bed cover, apron, face mask, etc.) as the primary materials. The commercial medical plastic materials are made of synthetic polymer, such as propylene (PP), in the forms of fibers. The physical and chemical properties of these synthetic materials are favorable for oil spill absorption, because the fibers are oleophilic and the structure is porous.

Further, in the disclosed technology, a device is made with the configuration of an outer bag filled with fillers. Both the bag and the filler are made from the fiber-based waste materials. The outside bag is coated with functional polymer to enhance the oil absorption and retention capacity of the device. The inside fillers are made of shredded fibrous plastic waste materials, to maximize the surface area of fillers and enhance oil absorption capacity. The dimensions and shape of the device can vary.

The disclosed technology turns waste to a valuable product, through the reuse of fiber-based plastic waste for oil spill cleanup. Relatedly, the disclosed technology is designed and evaluated with the configuration of an outer bag filled with fillers. Both the bag and the filler are made from the fiber-based waste material. The outside bag is coated with functional polymer to enhance the oil absorption and retention capacity of the device. The inside fillers are made of shredded fibrous plastic waste, to maximize the surface area of fillers and enhance oil absorption capacity.

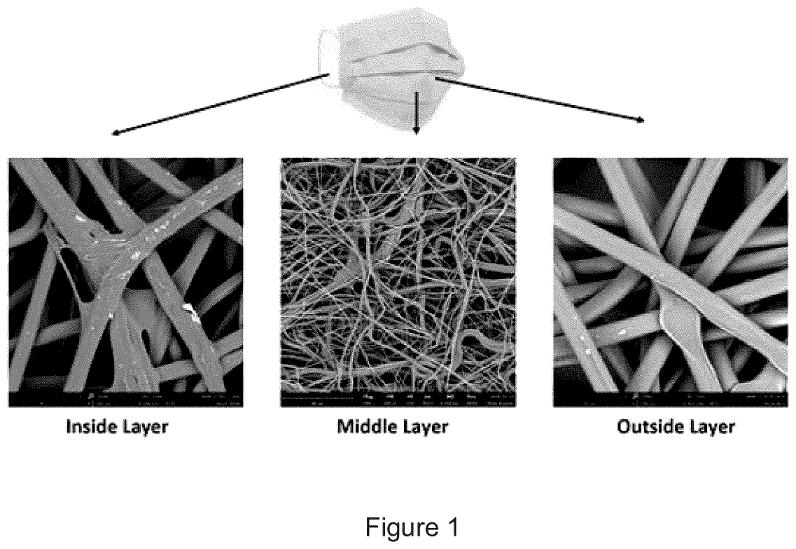

Regarding medical waste, the properties and structure of medical face masks provide various advantages for the disclosed technology. As seen in FIG. 1, a face mask mainly consists of three layers, including: (1) outer hydrophobic non-woven layer (translucent), (2) middle melt-blown layer (generally in white colour), and (3) an inner soft absorbent non-woven layer (green, blue, or white colour). All three layers are made of polypropylene. Moreover, as to decontamination of face masks, in one embodiment, the masks are collected and placed in “quarantine” for up to four days or another suitable timeframe. The face masks are then ground down into small pieces and subjected to ultraviolet light, hydrothermal treatment in an autoclave, or other suitable sterilization processes to ensure they are completely decontaminated before the recycling process begins. Notably, while the present embodiment uses face masks, other single-use medical fiber-based plastic waste, such as, but not limited to, aprons and bed covers, can be used. Moreover, while the present embodiment employs ultraviolet light exposure for decontamination, alternate embodiments include other suitable types of decontamination treatment and suitable combinations thereof.

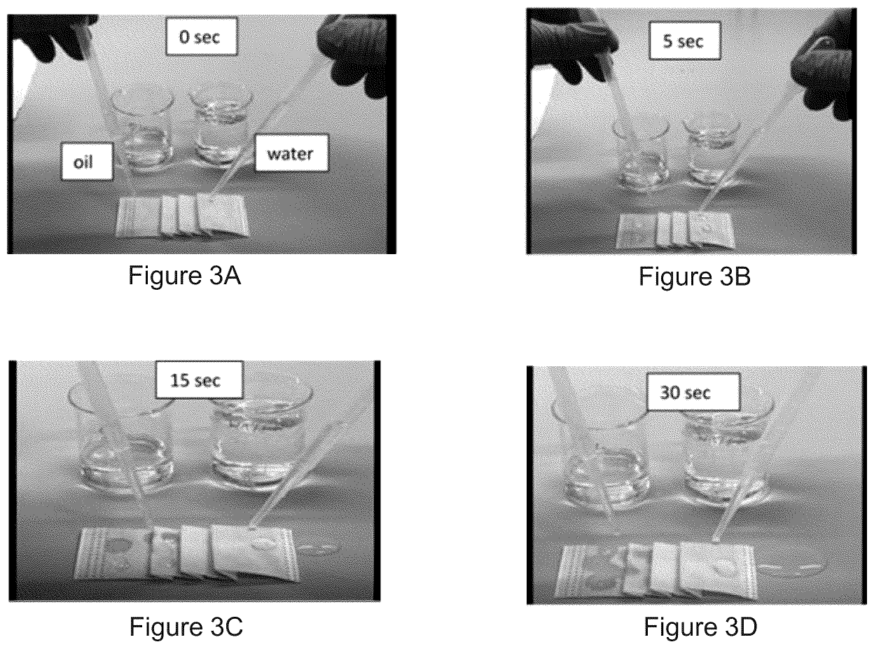

The disclosed technology was performance-tested via a surface wettability study. Surface wettability is a key factor in achieving the separation of oil from water. The surface wettability of the face mask layer is shown in FIGS. 3A-D. The figures show oil droplets quickly spread out and penetrate into the face mask in air at various time intervals, where the oil contact angle is around 0°. FIG. 3A shows 0 seconds, FIG. 3B shows 5 seconds, FIG. 3C shows 15 seconds, and FIG. 3D shows 30 seconds. In contrast, the figures show that water droplets were unable to permeate into face mask in air. As such, FIGS. 3A-D. support that the face mask layer possesses excellent hydro-phobicity and oleo-philicity. suggesting the great potential of face mask reuse as an oil spill absorbent. The results seen in FIGS. 3A-D can be attributed to the synergistic effect of low surface free energy and porous structure of face masks. This indicates the excellent hydro-phobicity and oleo-philicity of face mask, suggesting the great potential of face mask reused as oil spill absorbent.

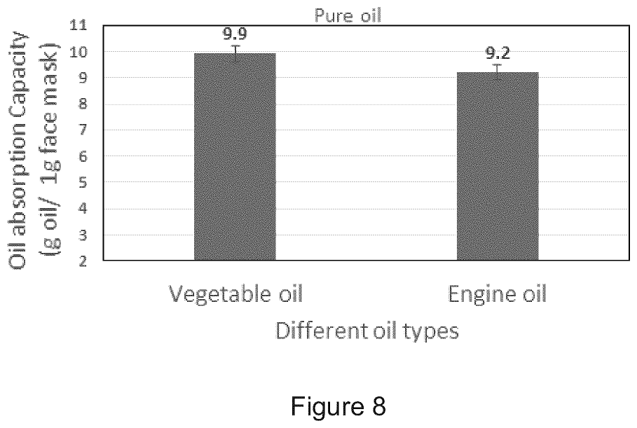

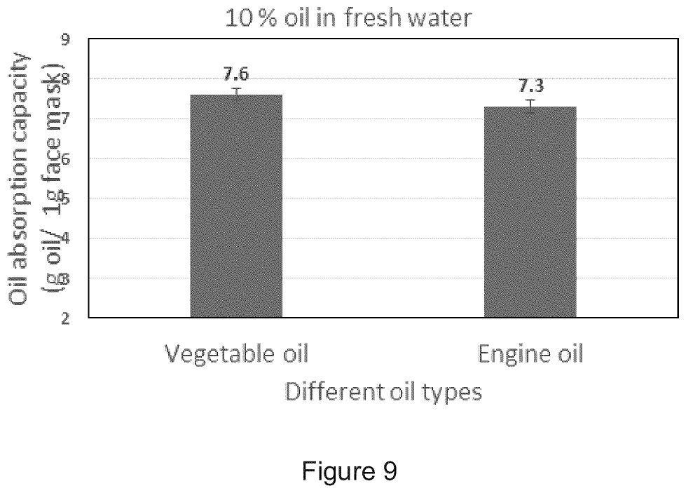

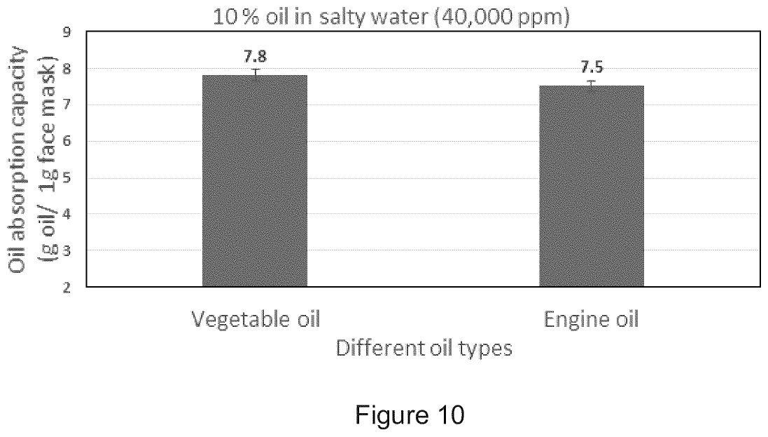

Face masks with dual special wettability are good candidates for efficiently separating oil from water, based on the above-proven excellent wettability and porous structure. To evaluate the oil absorption performance of face masks, a variety of oil/water mixtures were prepared under different conditions. The tested oils included vegetable soy bean oil and engine oil, and their performance under different water salinities was also tested. The results can be seen in FIGS. 8 to 10. It can be seen from the results that face masks can effectively absorb oil from water under different conditions of fresh water and salty water as seen in above figures.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An oil-absorption device comprising:
an outer bag, and
a filler, wherein the filler is comprised of fiber-based materials, and wherein the
filler is placed in and sealed in the outer bag.

2. The oil-absorption device of claim 1, wherein the outer bag is coated with a functional polymer.

3. The oil-absorption device of claim 1, wherein the functional polymer is one of Polyaniline, Polydimethylsiloxane, Poly(ethylene terephthalate), or Poly(vinylidene fluoride).

4. The oil-absorption device of claim 1, wherein the fiber-based materials are comprised of medical waste.

5. The oil-absorption device of claim 4, wherein the medical waste is comprised of an outer hydrophobic non-woven layer, a middle melt-blown layer, and an inner soft absorbent non-woven layer.

6. The oil-absorption device of claim 4, wherein the medical waste is one of a bed cover, an apron, or a face mask.

7. The oil-absporption device of claim 4, wherein the medical waste is hydro-phobic and oleo-philic.

8. The oil-absorption device of claim 1, wherein the filler is grounded.

9. The oil-absorption device of claim 1, wherein the filler is sanitized.

10. The oil-absorption device of claim 9, wherein the filler is sanitized via at least one of ultraviolet light treatment or hydrothermal treatment in an autoclave.

11. The oil-absorption device of claim 1, wherein the filler is quarantined for 4 days prior to being sanitized.

12. A method of assembling an oil-absorption device, the method comprising:
assembling an outer bag,
filling the other bag with a filler, wherein the filler is comprised of fiber-based materials, and
sealing the outer bag.

13. The method of claim 12, wherein the outer bag is coated with a functional polymer.

14. The method of claim 12, wherein the fiber-based materials are comprised of medical waste.

15. The method of claim 14, wherein the medical waste is comprised of an outer hydrophobic non-woven layer, a middle melt-blown layer, and an inner soft absorbent non-woven layer.

16. The method of claim 14, wherein the medical waste is one of a bed cover, an apron, or a face mask.

17. The method of claim 14, wherein the medical waste is hydro-phobic and oleo-philic.

18. The method of claim 12, further comprising quarantining, grounding, and sanitizing the filler.

19. The method of claim 18. wherein the filler is sanitized via at least one of ultraviolet light treatment or hydrothermal treatment in an autoclave.

20. The method of claim 18. wherein the filler is quarantined for 4 days.
